(19) United States
(12) Patent Application Publication
(10) Pub. No.: US 2026/0089609 A1
(43) Pub. Date: Mar. 26, 2026

(54) ENERGY-EFFICIENT COMMUNICATIONS IN SYSTEMS WITH SHARED RADIO UNITS

(71) Applicant: DISH Wireless L.L.C., Englewood, CO (US)

(72) Inventors: Mehdi Alasti, Arlington, VA (US); Khalid Walid Al-Mufti, Sterling, VA (US); Sourabh Gupta, Ashburn, VA (US); Siddhartha Chenumolu, Ashburn, VA (US)

(21) Appl. No.: 18/894,939

(22) Filed: Sep. 24, 2024

(51) Int. Cl. H04W 48/10; H04W 52/02; H04W 56/00

(52) U.S. Cl. CPC H04W 48/10; H04W 52/0206; H04W 56/001

(57) ABSTRACT

A method for controlling operations of multiple distributed units (DUs) that share a radio unit (RU) in a radio access network (RAN). The method comprises transmitting, by one or more computing devices to at least one DU of the multiple DUs, scheduling information indicative of corresponding time and frequency at which the at least one DU can communicate with the RU. The method further comprises transmitting, by the one or more computing devices to the at least one DU, information configured to instruct the at least one DU to refrain from transmitting synchronization information.

### TECHNICAL FIELD

This specification relates to network energy saving for wireless communication networks.

### BACKGROUND

To meet the growing demands for expanded mobile broadband connectivity, wireless communication technologies are advancing from the long-term evolution (LTE) technology to a next generation new radio (NR) technology, which may be referred to as 5^{th}-Generation (5G). For example, NR is designed to provide a lower latency, a higher bandwidth or a higher throughput, and a higher reliability than LTE.

5G radio access networks (RANs) may have characteristics of many kinds of traffic, large bandwidth, high frequency bands, and the like. This may inevitably lead to smaller single base station coverage, increased device complexity, and increased network scale. Consequently, energy consumption of 5G RANs can often be significant.

### SUMMARY

This specification describes technologies for network energy saving in wireless communication networks.

In general, one innovative aspect of the subject matter described in this specification can be embodied in a method of operating a radio unit (RU) shared by multiple distributed units (DUs) of a radio access network (RAN). The method includes transmitting, by one or more computing devices, a modified synchronization signal block (SSB). The modified SSB includes a first SSB. The first SSB includes time and frequency synchronization information for the multiple DUs for sharing the RU. The modified SSB further includes at least a second SSB different from the first SSB. The second SSB includes access information specific to a corresponding DU of the multiple DUs sharing the RU.

Implementations of the method can include one or more of the following features. The first SSB may further include access information specific to a coordinating DU of the multiple DUs. The coordinating DU may be configured to share time and frequency synchronization information among other DUs of the multiple DUs that share the RU. The functionalities of the shared RU may be implemented using the one or more computing devices. Transmitting the modified SSB can comprise transmitting the first SSB and the at least the second SSB in an information burst. The information burst can include multiple portions and each of the multiple portions of the information burst can be associated with an individual DU of the multiple DUs. The first SSB can comprise a primary synchronization signal (PSS) and a secondary synchronization signal (SSS). The access information in the second SSB can comprise information indicative of a physical broadcast channel (PBCH) associated with the corresponding DU. The PBCH can comprise a master information block (MIB) associated with the corresponding DU. The MIB can comprise information of a system information block (SIB) associated with an operator of the corresponding DU.

In another general aspect, an apparatus for operating a radio unit (RU) shared by multiple distributed units (DUs) of radio access network (RAN) is provided. The apparatus comprises one or more computing devices. The one or more computing devices are configured to transmit a modified synchronization signal block (SSB). The modified SSB includes a first SSB. The first SSB includes time and frequency synchronization information for the multiple DUs for sharing the RU. The modified SSB further includes at least a second SSB different from the first SSB. The second SSB includes access information specific to a corresponding DU of the multiple DUs sharing the RU.

Implementations of the apparatus can include one or more of the following features. The first SSB may further include access information specific to a coordinating DU of the multiple DUs. The coordinating DU may be configured to share time and frequency synchronization information among other DUs of the multiple DUs that share the RU. The one or more computing devices may be configured to implement functionalities of the shared RU. Transmitting the modified SSB can comprise transmitting the first SSB and the at least the second SSB in an information burst. The information burst can include multiple portions and each of the multiple portions of the information burst can be associated with an individual DU of the multiple DUs. The first SSB can comprise a primary synchronization signal (PSS) and a secondary synchronization signal (SSS). The access information in the second SSB can comprise information indicative of a physical broadcast channel (PBCH) associated with the corresponding DU. The PBCH can comprise a master information block (MIB) associated with the corresponding DU. The MIB can comprise information of a system information block (SIB) associated with an operator of the corresponding DU.

In another general aspect, a non-transitory computer readable medium for operating a radio unit (RU) shared by multiple distributed units (DUs) of a radio access network (RAN) is provided. The non-transitory computer readable medium stores instructions that are executable by one or more computing devices, and upon such execution cause the one or more computing devices to perform operations. The operations include transmitting a modified synchronization signal block (SSB). The modified SSB includes a first SSB. The first SSB includes time and frequency synchronization information for the multiple DUs for sharing the RU. The modified SSB further includes at least a second SSB different from the first SSB. The second SSB includes access information specific to a corresponding DU of the multiple DUs sharing the RU.

Implementations of the non-transitory computer readable medium can include one or more of the following features. The first SSB may further include access information specific to a coordinating DU of the multiple DUs. The coordinating DU may be configured to share time and frequency synchronization information among other DUs of the multiple DUs that share the RU. The one or more computing devices may implement functionalities of the shared RU. Transmitting the modified SSB can comprise transmitting the first SSB and the at least the second SSB in an information burst. The information burst can include multiple portions and each of the multiple portions of the information burst can be associated with an individual DU of the multiple DUs. The first SSB can comprise a primary synchronization signal (PSS) and a secondary synchronization signal (SSS). The access information in the second SSB can comprise information indicative of a physical broadcast channel (PBCH) associated with the corresponding DU. The PBCH can comprise a master information block (MIB) associated with the corresponding DU. The MIB can comprise information of a system information block (SIB) associated with an operator of the corresponding DU.

In a further general aspect, a method for controlling operations of multiple distributed units (DUs) that share a radio unit (RU) in a radio access network (RAN) is provided. The method includes transmitting, by one or more computing devices to at least one DU of the multiple DUs, scheduling information. The scheduling information is indicative of corresponding time and frequency at which the at least one DU can communicate with the RU. The method further includes transmitting, by the one or more computing devices to the at least one DU, information configured to instruct the at least one DU to refrain from transmitting synchronization information.

Implementations of the method can include one or more of the following features. The one or more computing devices may constitute a portion of a RAN Intelligent Controller (RIC). The method may further include transmitting, by the one or more computing devices to the at least one DU, information configured to instruct the at least one DU to provide access information specific to the at least one DU. The synchronization information may include a primary synchronization signal (PSS) and a secondary synchronization signal (SSS). The access information specific to the at least one DU may include information indicative of a physical broadcast channel (PBCH) associated with the at least one DU. The PBCH may comprise a master information block (MIB) associated with the at least one DU.

In another general aspect, an apparatus for controlling operations of multiple distributed units (DUs) that share a radio unit (RU) in a radio access network (RAN) is provided. The apparatus includes one or more computing devices. The one or more computing devices are configured to transmit to at least one DU of the multiple DUs scheduling information. The scheduling information is indicative of corresponding time and frequency at which the at least one DU can communicate with the RU. The one or more computing devices are further configured to transmit to the at least one DU information configured to instruct the at least one DU to refrain from transmitting synchronization information.

Implementations of the apparatus can include one or more of the following features. The one or more computing devices may be configured to constitute a portion of a RAN Intelligent controller (RIC). The one or more computing devices may be configured to transmit to the at least one DU information configured to instruct the at least one DU to provide access information specific to the at least one DU. The synchronization information may include a primary synchronization signal (PSS) and a secondary synchronization signal (SSS). The access information specific to the at least one DU may include information indicative of a physical broadcast channel (PBCH) associated with the at least one DU. The PBCH may comprise a master information block (MIB) associated with the at least one DU.

In another general aspect, a non-transitory computer readable medium for controlling operations of multiple distributed units (DUs) that share a radio unit (RU) in a radio access network (RAN) is provided. The non-transitory computer readable medium stores instructions that are executable by one or more computing devices, and upon such execution cause the one or more computing devices to perform operations. The operations include transmitting to at least one DU of the multiple DUs scheduling information. The scheduling information is indicative of corresponding time and frequency at which the at least one DU can communicate with the RU. The operations further include transmitting to the at least one DU information configured to instruct the at least one DU to refrain from transmitting synchronization information.

Implementations of the non-transitory computer readable medium can include one or more of the following features. The one or more computing devices may constitute a portion of a RAN Intelligent controller (RIC). The operations may further include transmitting to the at least one DU information configured to instruct the at least one DU to provide access information specific to the at least one DU. The synchronization information may include a primary synchronization signal (PSS) and a secondary synchronization signal (SSS). The access information specific to the at least one DU may include information indicative of a physical broadcast channel (PBCH) associated with the at least one DU. The PBCH may comprise a master information block (MIB) associated with the at least one DU.

The subject matter described in this specification can be implemented in particular embodiments so as to realize one or more of the following advantages.

In some cases, the technology described herein can enable efficient sharing of hardware or virtualized software required for operating RANs. For example, in some implementations, the RAN may be realized in a split O-RAN architecture. This split may enable operators of RANs to share one or more units of this split O-RAN architecture. In an example, two or more operators of RANs may share a common (or shared) radio unit (RU). Compared to having each operator running its own RU, hardware and/or software requirements may be reduced. This can enable the reduction of energy consumption of RANs, and hence, reduce greenhouse emissions and operational costs. This may also increase the operational efficiency.

In some cases, the technology described herein can enable sharing information among operators of RANs. For example, when two or more operators share one or more units in a split O-RAN architecture, information that may be identical among the two or more operators may be shared. For example, synchronization information (e.g., synchronization signals such as Primary Synchronization Signal (PSS) and Secondary Synchronization Signal (SSS)) and/or access information (e.g., a master information block (MIB)) may include components that are identical for two or more operators. Instead of each operator broadcasting such information, the common information may only be provided by one of the operators, and all other operators may refrain from providing the same information. The information provided by one of the operators may therefore be shared among the operators of the shared RU.

In some cases, this may avoid the transmission of such information by some of the operators of a shared RU. Therefore, energy consumption for transmission can be reduced. This reduces greenhouse transmissions, and hence, operational costs for RANs.

In some cases, the energy consumption may even further be reduced. When two or more operators share one or more units in a split O-RAN architecture and one or more operators thereof refrain from transmission of signals, they may additionally power off hardware components (e.g., power amplifiers, etc.) that may otherwise be used for transmission of such signals. Powering off hardware components that may not be used reduces energy consumption. This again reduces greenhouse emissions, and hence, operational costs for operating RANs.

In some cases, the technology described herein can also allow for increased data throughput. For example, when two or more operators share RUs in a split O-RAN architecture that separates distributed units (DUs) and RUs of a gNB, and one or more such DUs do not need to transmit synchronization signals, the consequently freed up resources/bandwidth may be used for data transmission, thereby providing for higher data throughput.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example of a split of a BS in an O-RAN architecture.

FIG. 2 is an example of a shared RU architecture.

FIG. 3 is an example of using a modified SSB in a shared RU architecture.

FIG. 4 is another example of using a modified SSB in a shared RU architecture.

FIG. 5 is another of using a modified SSB in a shared RU architecture.

FIG. 6 is an example flowchart for a method of using a modified SSB in a shared RU architecture.

FIG. 7 is an example shared RU architecture.

FIG. 8 is an example flowchart for a method of controlling multiple DUs in a shared RU architecture.

Like reference numbers and designations in the various drawings indicate like elements.

### DETAILED DESCRIPTION

In latest wireless communication systems such as a 5G O-RAN, functionalities of a base station (BS)—also known as gNB for 5G O-RANs—can be split into multiple functional units such as a central unit (CU), a distributed unit (DU), and a radio unit (RU). Some recent implementations of 5G O-RAN also support an architecture where multiple DUs (each typically assigned to a separate operator) share a RU that splits the available spectrum of communication into multiple chunks, and each operator utilizes the corresponding assigned chunk as the operator's channel bandwidth. To ensure interference-free communications, each operator transmits synchronization information (e.g., via a synchronization signal block—SSB) over their assigned portion of the spectrum. Because signals and channels corresponding to the different operators are to be synchronized in time and frequency for interference-free operations, transmitting synchronization information separately from each operator can be redundant—resulting in less-than-optimal bandwidth/resource usage. The technology described herein espouses the use of shared synchronization information (e.g., a primary synchronization signal—PSS, and a secondary synchronization signal—SSS) transmitted by one coordinating operator such that the same synchronization information can be used by other operators sharing the RU. This in turn allows the other operators to transmit other relevant operator-specific information (e.g., via a master information block—MIB in 5G O-RANs) without the overhead of transmitting synchronization information. This in turn increases available bandwidth and reduces energy consumption in the shared-RU architecture compared to the implementations where each operator transmits synchronization information.

Wireless communication systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems. These multiple access technologies have been adopted in various telecommunication standards to provide a common protocol that enables different wireless devices to communicate on a geographical level (e.g., municipal, national, regional, global level). An example telecommunication standard is 5G New Radio (NR). 5G is part of a continuous mobile broadband evolution promulgated by Third Generation Partnership Project (3GPP) to meet new requirements associated with latency, reliability, security, scalability (such as with Internet of Things (IoT)), and other requirements. 5G includes services associated with enhanced mobile broadband (eMBB), massive machine type communications (mMTC), and ultra-reliable low latency communications (URLLC).

Energy saving and power reduction are an area of prime interest for wireless communication systems. Mobile network operators often face requirements to reduce greenhouse emissions and energy consumption. For example, authorities ranging from local governments to international organizations have formulated and are enforcing environmental requirements that mobile network operators need to comply with. In addition, energy consumption for operating wireless communication systems may account for a high percentage of operating costs, and operating base stations can contribute significantly to the network energy consumption. Reducing the energy consumption of base stations can therefore significantly reduce the operator costs. Energy consumption of a base station may be split into a static part and a dynamic part. The static part may refer to the energy consumption that may be consumed all the time to maintain the necessary operation, even in the absence of data transmission/reception. The dynamic part may refer to the energy consumption that may only be consumed during data transmission/reception.

A large part of the network energy consumption may be attributed to the power usage in base stations of a wireless communication network. In addition to power consumed for active cooling, different base station components, whether in a receiver or transmitter, need power to perform baseband processing, signal processing and many other computing tasks. In particular, radio frequency components in a base station, mainly the power amplifier in a transmitter, consume large amounts of power. Part of the power transmitted from an antenna can be lost in the power amplifier. Sometimes the power amplifier efficiency (defined as a ratio between the power amplifier output power and input power) can be less than 50%. Such power loss may be avoided by temporarily turning off the power amplifier.

Energy saving mechanisms are becoming an integral part of the new generation radio access networks, and consequently, of most wireless communication systems. A good energy saving solution needs to ensure no service degradation or inefficiencies in the network. A common goal may be to reduce the “on time” of the power amplifier. By reducing the power amplifier on time, a power amplifier can consume less power and achieve energy savings in the base station. The power amplifier on time may be minimized if the transmission management unit or scheduler in a base station can schedule downlink transmissions to the extent that, for a certain period of time duration (e.g., a frame, a subframe or a few symbols or time units), there is no downlink traffic (voice or data) transmission. Accordingly, minimizing power amplifier on time may focus on reducing dynamic energy consumption. The present disclosure focuses on reducing static power consumption which may be used additionally with reducing power amplifier on time.

The following description is directed to certain implementations for the purposes of describing the innovative aspects of this disclosure. The described implementations may be implemented in any device, system or network that is capable of transmitting and receiving radio frequency (RF) signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), or other known signals that are used to communicate within a wireless, cellular or internet of things (IoT) network technology, such as a system utilizing 3G, 4G or 5G, or further implementations thereof. Although the following description may be focused on 5G, the concepts described herein may be applicable to other similar areas, such as LTE, LTE-A, CDMA, GSM, and other wireless technologies including future (e.g., 6G) technologies.

A wireless communications system (which may also be referred to as a wireless wide area network (WWAN)) may include base stations (BSs), user equipments (UEs), and a core network (e.g., a 5G core network (5G-CN)). The BSs may include macrocells (high power cellular base station) or small cells (low power cellular base station). The macrocells may include BSs. The small cells may include femtocells, picocells, and microcells. The BSs may wirelessly communicate with the UEs. Each of the BSs may provide communication coverage for a respective geographic coverage area. There may be overlapping geographic coverage areas. For example, a small cell may have a coverage area that overlaps the coverage area of one or more macro BSs. A network that includes both small cell and macrocells may be a heterogeneous network. A heterogeneous network also may include Home Evolved Node Bs (eNBs) (HeNBs), which may provide service to a restricted group known as a closed subscriber group (CSG). Communication links between the BSs and the UEs may include uplink (UL—which may also be referred to as reverse link) transmissions from a UE to a BS and/or downlink (DL—which may also be referred to as forward link) transmissions from a BS to a UE. The communication links may use multiple-input and multiple-output (MIMO) antenna technology, including spatial multiplexing, beamforming, or transmit diversity. The communication links may be through one or more carriers. The BSs and UEs may use a spectrum up to, e.g., 3, 5, 10, 15, 20, 100, 400, etc. MHz bandwidth per carrier allocated in a carrier aggregation. The carriers may or may not be adjacent to each other.

The BS, whether a small cell or a large cell (such as macro BS), may include or be referred to as a gNB, Node B, eNB, an access point, a base transceiver station, a radio base station, a radio transceiver, a transceiver function, a basic service set (BSS), an extended service set (ESS), a transmit receive pair (TRP), or some other suitable terminology. The BS may provide an access point to the CN for a UE. Some BSs, such as gNB may operate in one or more frequency bands within the electromagnetic spectrum. The electromagnetic spectrum may be subdivided, based on frequency/wavelength, into various classes, bands, channels, etc. In 5G two operating bands may be identified as frequency range designations FR1 (410 MHz-7.125 GHz), FR2_1 (24.25 GHz-52.6 GHz) and FR2_2 (52.6 GHz-71 GHz).

Communications using the FR2_1 and FR2_2 radio frequency bands have extremely high path loss and a short range. To compensate for the path loss and short range, the BS may utilize beamforming with the UE.

Examples of UEs include a cellular phone, a smart phone, a session initiation protocol (SIP) phone, a laptop, a personal digital assistant (PDA), a satellite radio, a global positioning system, a multimedia device, a video device, a digital audio player (such as a MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs may be referred to as IoT devices (such as a parking meter, gas pump, vehicles, etc.). The UE also may be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The CN may include an Access and Mobility Management Function (AMF), Session Management Function (SMF), and a User Plane Function (UPF). The AMF and SMF may be the control node that processes the signaling between the UEs and the core network. The AMF and SMF may also provide QoS flow and session management. All user Internet protocol (IP) packets may be transferred through the UPF. The UPF may provide UE IP address allocation as well as other functions. The UPF may be connected to the IP Services. The IP Services may include the Internet, an intranet, an IP Multimedia Subsystem (IMS), or other IP services.

The BSs may be configured in an Open Radio Access Network (O-RAN) architecture, where functionality is split between multiple units such as one or more central units (CU), one or more distributed units (DUs), or one or more radio units (RUs). Such architectures may be configured to utilize a protocol stack that is logically split between one or more units (such as one or more CUs and one or more DUs). In some aspects, one or more DUs may be co-located with a CU, or may be geographically distributed. The DUs may be implemented to communicate with one or more RUs. Each of the CU, DU and RU may also be implemented as virtual units.

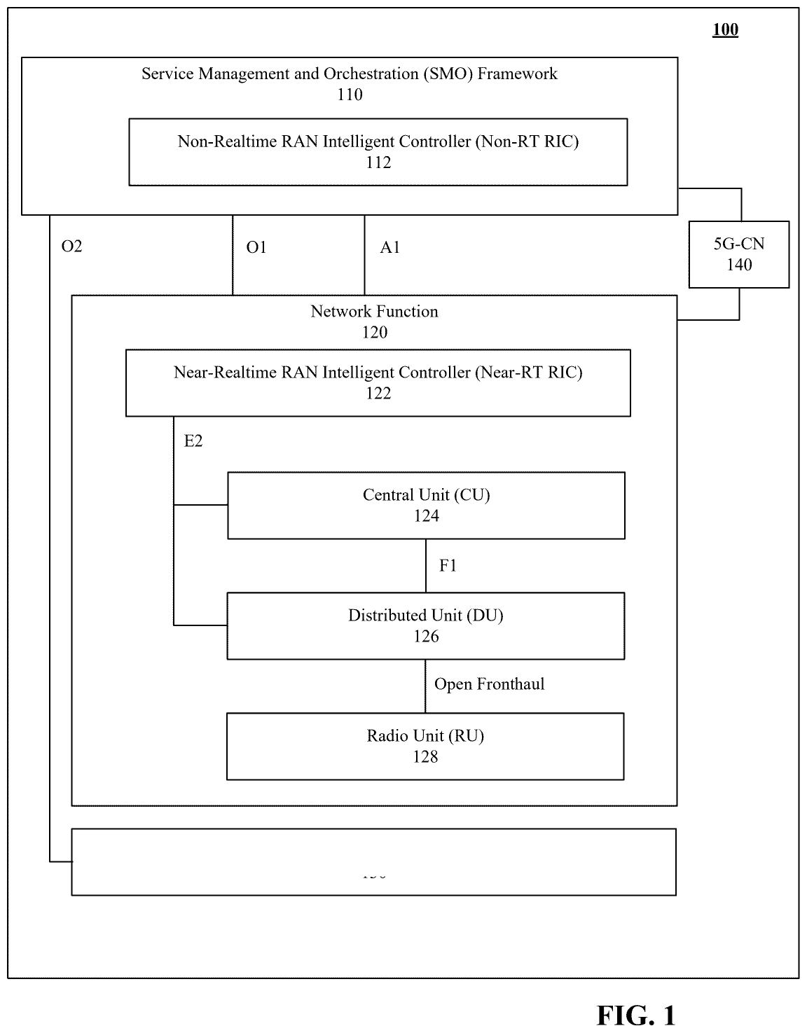

FIG. 1 shows an example of a split of a BS in an O-RAN architecture 100. This O-RAN architecture 100 may comprise a service management and orchestration (SMO) Framework 110, network functions (NFs) 120, and an open cloud (O-Cloud) 130. A connection to a CN such as a 5G-CN 140 may be established via a 3GPP-defined interface NG. The SMO Framework 110 may host a Non-Realtime RAN Intelligent Controller (Non-RT RIC) 112. The NFs 120 may comprise a Near-Real Time RIC (Near-RT RIC) 122 as well as entities such as one or more Central Units (CUs) 124, one or more Distributed Units (DU) 126, one or more Radio Units (RUs) 128, etc. Although only one CU 124, one DU 126, and one RU 128 is shown, other implementations are possible. In some implementations, there can be one or more CUs 124, one or more DUs 126, and one or more RUs 128.

In some implementations, each of the units, i.e., the CU 124, the DU 126, the RU 128, as well as the Near-RT RICs 122, the Non-RT RICs 112 and the SMO Framework 110, may include one or more interfaces or be coupled to one or more interfaces configured to receive or transmit signals, data, or information via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

A CU 124 may communicate with the DU 126 via respective links, such as an F1 interface. The DU 126 may communicate with the RU 128 via a respective fronthaul link, such as an Open Fronthaul Management (M)-plane interface. The RU 128 may communicate with respective UEs (not shown) via one or more RF access links. In some implementations, a UE may be simultaneously served by multiple RUs 128.

In some aspects, the CU 124 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 124. The CU 124 may be configured to handle user plane functionality (e.g., Central Unit-User Plane (CU-UP)), control plane functionality (e.g., Central Unit-Control Plane (CU-CP)), or a combination thereof. In some implementations, the CU 124 can be split into one or more CU-UP units and one or more CU-CP units. The CU-UP unit may communicate bidirectionally with the CU-CP unit via an interface, such as the E1 interface. The CU 124 can be implemented to communicate with the DU 126, as necessary, for network control and signaling.

The DU 126 may correspond to a logical unit that may control the operation of one or more RUs 128. In some aspects, the DU 126 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by 3GPP. Each layer (or module) can be implemented with an interface configured to communicate signals with other layers (and modules) hosted by the DU 126, or with the control functions hosted by the CU 124.

Lower-layer functionality can be implemented by the RU 128. In some implementations, an RU 128, controlled by a DU 126, may correspond to a logical node that hosts radio frequency processing functions, or lower level PHY layer functions (such as performing fast Fourier transform (FFT), inverse FFT (iFFT), digital beamforming, physical random access channel (PRACH) extraction and filtering, or the like), or both. RU 128 can be implemented to handle over the air (OTA) communication with one or more UEs. In some implementations, real-time and non-real-time aspects of control and user plane communication with the RU 128 can be controlled by the corresponding DU 126. In some scenarios, this configuration can enable the DU 126 and the CU 124 to be implemented in a cloud-based RAN architecture.

The SMO Framework 110 is an entity that provides various management services and network management functions. The SMO Framework 110 may be configured to support RAN deployment and provisioning of non-virtualized and virtualized network elements. For non-virtualized network elements, the SMO Framework 110 may be configured to support the deployment of dedicated physical resources for RAN coverage requirements which may be managed via an operations and maintenance interface (such as an O1 interface). For virtualized NFs, the SMO Framework 110 may be configured to interact with the O-Cloud 130 to perform NF life cycle management (such as to instantiate virtualized NFs) via a cloud computing platform interface (such as an O2 interface). Such virtualized NFs can include, but are not limited to, the NF 120 including Near-RT RIC 122, CU 124, DU 126, and RU 128.

The Non-RT RIC 112 may have functions of micro-service and policy management, radio network analysis, training of an artificial intelligence model, etc. The Non-RT RIC 112 may be configured to include a logical function that enables non-RT control and optimization of RAN elements and resources, Artificial Intelligence/Machine Learning (AI/ML) workflows including model training and updates, or policy-based guidance of applications/features in the Near-RT RIC 122. The Non-RT RIC 112 may be coupled to or communicate with the Near-RT RIC 122, e.g., via an A1 interface. The Near-RT RIC 122 may be configured to include a logical function that enables near-real-time control and optimization of RAN elements and resources via data collection and actions over an interface (such as via an E2 interface) connecting one or more CUs 124, one or more DUs 126, or both with the Near-RT RIC 122.

In some aspects, to generate AI/ML models to be deployed in the Near-RT RIC 122, the Non-RT RIC 112 may receive enrichment information or parameters from external servers via an external interface (not shown). Such information may be utilized by the Near-RT RIC 122 and may be received at the SMO Framework 110 or the Non-RT RIC 112 from non-network data sources or from NFs 120. In some examples, the Non-RT RIC 112 or the Near-RT RIC 122 may be configured to tune RAN behavior or performance. For example, the Non-RT RIC 112 may monitor long-term trends and patterns for performance and employ AI/ML models to perform corrective actions through the SMO Framework 110 (such as reconfiguration via O1) or via creation of RAN management policies (such as A1 policies).

The O-Cloud 130 may host many of the O-RAN NFs 120. It may be a cloud computing platform comprising a collection of physical infrastructure nodes that meet O-RAN requirements to host the relevant O-RAN NFs 120 (such as Near-RT RIC 122, CU 124, and O-DU 126, etc.), the supporting software components (such as Operating System, Virtual Machine Monitor, Container Runtime, etc.) and the appropriate management and orchestration functions.

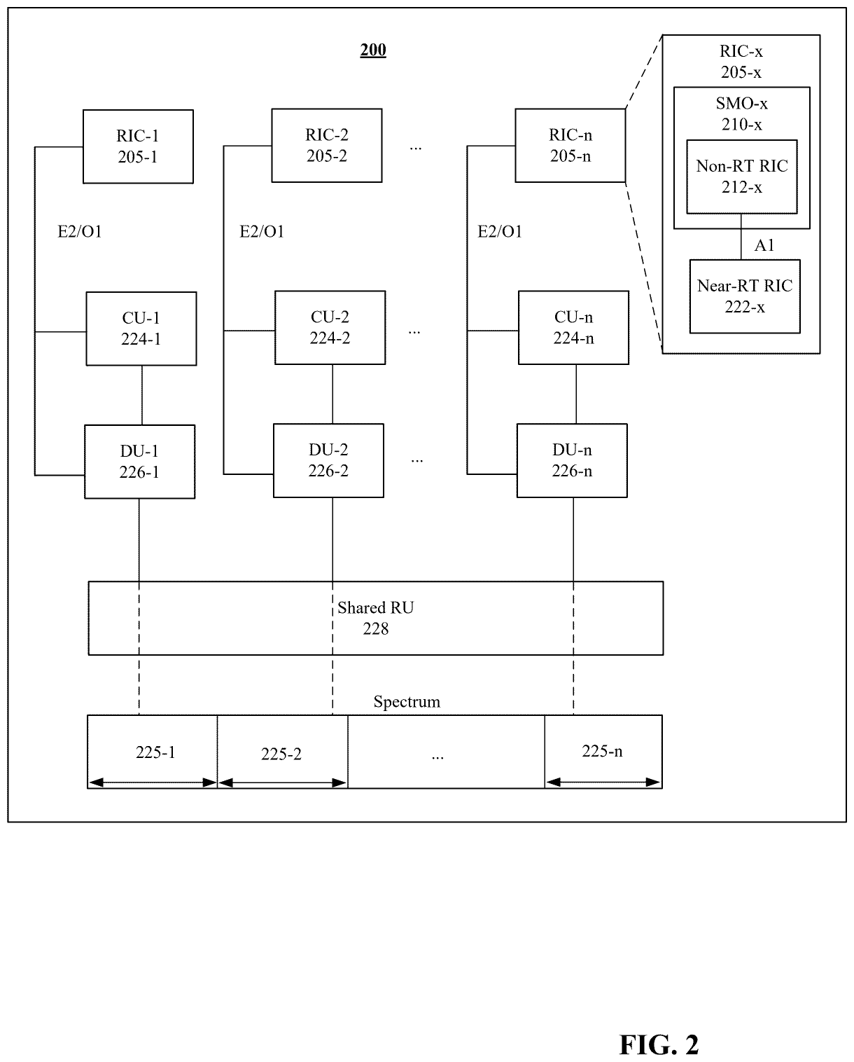

The O-RAN architecture 100 allows for efficient RAN sharing to reduce operator costs. One example of RAN sharing is shown in FIG. 2 which is denoted herein as shared RU architecture 200.

In FIG. 2, multiple sharing operators share RU 228. The number of sharing operators may be any number including but not limited to 2, 3, 4, 5, 6, etc. Each sharing operator x may run its own RIC-x 205-x, CU-x 224-x, and DU-x 226-x. Similarly as shown in FIG. 1, a RIC-x 205-x may comprise a Non-RT RIC-x 212-x hosted by an SMO-x 210-x and a Near-RT RIC-x 222-x. Alternatively, a RIC-x 205-x may comprise a stand-alone Non-RT RIC-x 212-x. In a further alternative, RIC-x 205-x may comprise a stand-alone Non-RT RIC-x 212-x and a Near-RT RIC-x 222-x.

The sharing operators x may share the shared RU 228. The available spectrum may be split up in multiple non-overlapping chunks 225-x. In an example with two operators 1 and 2, a 30 MHz bandwidth may be split up into two consecutive non-overlapping chunks. A first chunk of 15 MHz 225-1 may be associated with DU-1 226-1 of a first operator 1. A second chunk of the remaining 15 MHz 225-2 may be associated with DU-2 226-2 of a second operator 2. In another example with four operators, a 30 MHz bandwidth may be split up into four consecutive and non-overlapping chunks. A first chunk of, for example 10 MHz 225-1 may be associated with DU-1 226-1 of first operator 1. A second chunk of, for example 10 MHz 225-2 may be associated with DU-2 226-2 of second operator 2. A third chunk of, for example 5 MHz 225-3 may be associated with DU-3 226-3 of third operator 3, and a fourth chunk of, for example 5 MHz 225-4 may be associated with DU-4 226-4 of fourth operator 4. Any number of operators may be used for RU sharing and any split of the spectrum may be possible. Each operator x may use the assigned chunk of spectrum as channel bandwidth.

When a UE attempts to connect to a new cell associated with a BS, the BS may transmit synchronization information to facilitate synchronization in time and frequency for interference-free communications for the UE. The synchronization information may include a primary synchronization signal (PSS) and a secondary synchronization signal (SSS). For the UE the obtain initial network access, the BS can broadcast access information associated with the network. The access information can comprise information indicative of a physical broadcast channel (PBCH) and may include a master information block (MIB). The access information may also include one or more system information blocks (SIBs). In some aspects, the first SIB or SIB-1 may contain information that a UE may use to obtain other SIBs.

The access information may include configuration parameters that the UE may use to access the BS. Example configuration parameters may indicate whether the UE may access the BS or whether the UE belongs to a type or category which has been barred from accessing the BS. Example configuration parameters may also be access control parameters. Additionally, example configuration parameters may be random access (RACH) parameters that the UE may use to perform a RACH procedure that connects the UE to BS.

In some aspects, a UE attempting to access the network may perform an initial cell search by detecting a PSS. The UE may then receive an SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE may receive a MIB. The MIB may include system information for initial network access and scheduling information for the SIBs. After obtaining the MIB and one or more of the SIBs, the UE can perform a RACH procedure to establish a connection with the BS.

In some instances, the BS may broadcast the PSS, the SSS, and/or the MIB in the form of synchronization signal block (SSBs) over a physical broadcast control channel (PBCH) and may broadcast the one or more SIBs over a physical downlink shared channel (PDSCH). SSBs may be transmitted with a periodicity of 20 ms. They may also be transmitted with a periodicity of 5 ms, 10 ms, 40 ms, 80 ms, and 160 ms. SSBs may also be transmitted as a burst or set. Such a burst or set of SSBs (in the following SSB burst) may comprise a number of SSBs. The number of SSBs within an SSB burst may vary depending on subcarrier spacing and frequency range. For example, the transmission of an SSB burst may be confined to a 5 ms window. The maximum number of SSBs within an SSB burst may be 4 for frequency ranges up to 3 GHz, 8 for 3 GHz to 7.125 GHz, or 64 for FR2_1 and FR2_2. The number of SSBs in an SSB burst may be chosen such as to achieve a trade-off between coverage and resource overhead. This number may be configurable. In some implementations, the SSB burst may not be limited to a 5 ms window. Other window sizes may be possible as well including window sizes smaller than 5 ms (such as 2 ms, 3 ms, 4 ms, etc.) and window sizes greater that 5 ms (such as 8 ms, 10 ms, 15 ms, etc.). The number of SSBs in an SSB burst may also be lower or higher than the given examples.

Coming back to the example of a shared RU architecture 200 of FIG. 2, each operator may broadcast its own SSB over its channel bandwidth. The SSB is an “always on”signal. Therefore, for the example of a shared RU architecture 200 as shown in FIG. 2, the transmission of the SSB by each individual operator may add to the overall energy consumption of the RAN. The transmission of SSB-x by operator x at its associated spectrum chunk may significantly contribute to the overall energy consumption of RAN. Therefore, it may be desirable to use SSBs more efficiently to reduce the static energy consumption of the RAN. Reducing the static energy consumption may reduce the overall energy consumption, and hence, reduce greenhouse emissions and total operator costs.

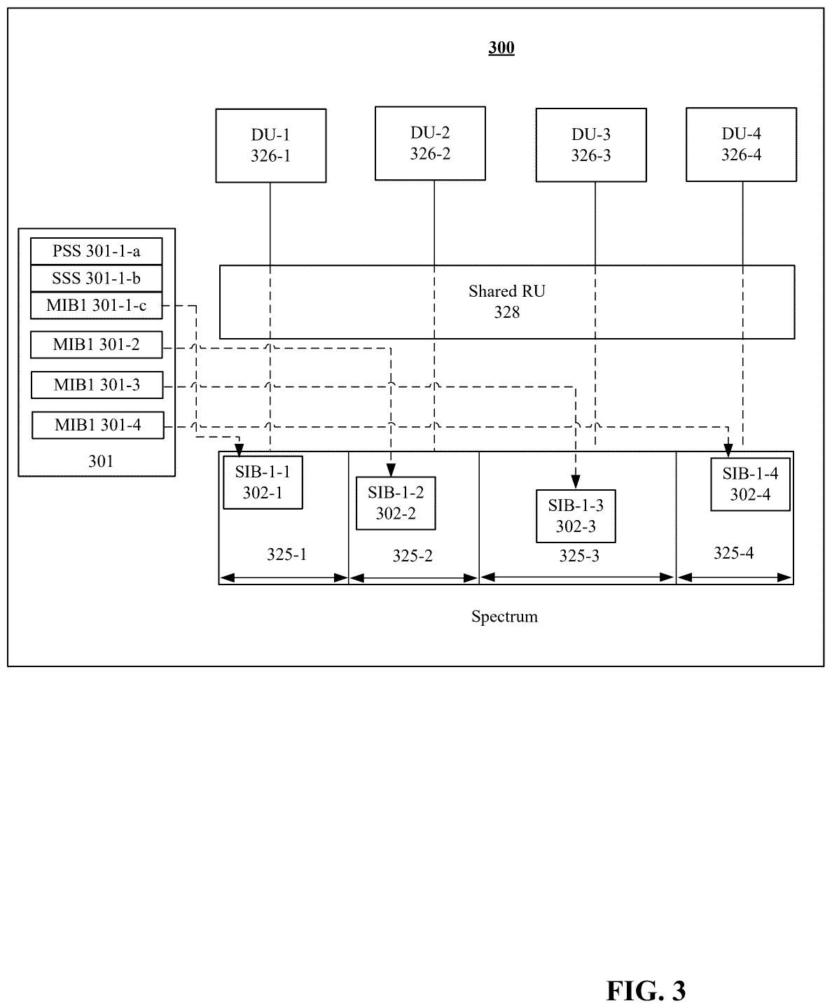

FIG. 3 shows an example 300 of using a modified SSB 301 efficiently among multiple sharing operators in the shared RU architecture 200 according to FIG. 2. For ease of simplicity, the RICs RIC-x and the CUs CU-x are omitted in the example 300 of FIG. 3.

From the example discussed above with reference to FIG. 2, although each operator x may transmit its own SSB-x, the PSS and SSS may be the same for each SSB-x. Differences between the SSBs of the sharing operators may only be found in the MIBs. The MIBs broadcast by the various sharing operators may be different. Therefore, in order to avoid the transmissions of multiples of potentially identical information or signals, such potentially identical information or signals may be shared among the multiple sharing operators and may therefore be transmitted only once.

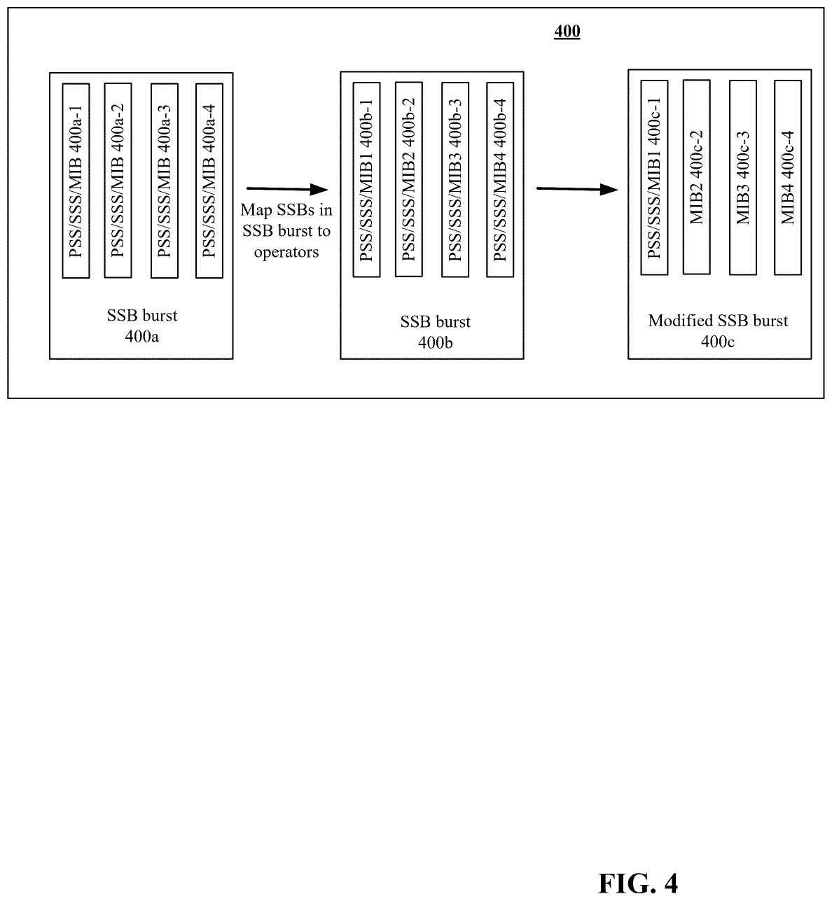

In the example 300 of FIGS. 3, 4 sharing operators are illustrated, each having a DU DU-x 326-x. Accordingly, operator 1 has DU-1 326-1, operator 2 has DU-2 326-2, operator 3 has DU-3 326-3, and operator 4 has DU-4 326-4. These four DUs 326-1 to 326-4 share the shared RU 328, and the available spectrum may be split up in non-overlapping chunks 325-1, 325-2, 325-3, and 325-4. Spectrum chunk 325-1 is associated with DU-1 of operator 1, spectrum chunk 325-2 is associated with DU-2 of operator 2, spectrum chunk 325-3 is associated with DU-3 of operator 3, and spectrum chunk 325-4 is associated with DU-4 of operator 4. In an example, one of the DUs may be a coordinating DU which may be configured to schedule or assign the spectrum chunks to the DUs. For example, the coordinating DU may transmit scheduling information to the other DUs. This scheduling information may be indicative of corresponding time and frequency at which the DUs can communicate with the RU. In an example, the information indicative of time and frequency allocations among the multiple DUs for sharing the RU may comprise information on the spectrum chunks 325-1 to 325-4 associated with the four DUs 326-1 to 326-4. In an example, the information on the spectrum chunks 325-1 to 325-4 may include a starting frequency, an end frequency, and/or a bandwidth of the spectrum chunks 325-1 to 325-4, and/or a duration during which a spectrum chunk may be used (e.g., 10 MHz from 7 am to 6 pm, and 5 MHz otherwise). In other implementations, other information that identify the spectrum chunks 325-1 to 325-4 may be used. In the given example, DU-1 326-1 may be identified as coordinating DU. In another example, the shared RU 328 may split up the spectrum.

The shared RU 328 may transmit the modified SSB 301. The modified SSB 301 in the given example comprises a first SSB 301-1, a second SSB 301-2, a third SSB 301-3, and a fourth SSB 301-4. The first SSB 301-1 may comprise time and frequency synchronization for the multiple DUs for sharing the RU. In an example, the time and frequency synchronization information may comprise PSS and SSS. The first SSB 301-1 of the modified SSB 301 may comprise PSS 301-1-a and SSS 301-1-b. The first SSB 301-1 may also comprise access information 301-1-c specific to the coordinating DU 326-1. In the given example, this access information 301-1-c is the MIB associated with DU-1 326-1. The further SSBs 301-2 to 301-4 of the modified SSB 301 may comprise access information specific to a corresponding DU of the multiple DUs sharing the RU 328. The access information may comprise information indicative of a physical broadcast channel (PBCH) associated with the corresponding DU. The PBCH may comprise a MIB associated with the corresponding DU. In the given example, the second SSB 301-2 of the modified SSB 301 may comprise the MIB associated with DU-2 326-2, the third SSB 301-3 of the modified SSB 301 may comprise the MIB associated with DU-3 326-3, and the fourth SSB 301-4 of the modified SSB 301 may comprise the MIB associated with DU-4 326-4. Each MIB may comprise information of a SIB, e.g., SIB-1 associated with an operator of the corresponding DU. Each MIB may point to a corresponding SIB-1 allocated somewhere in the spectrum chunk that is allocated to the corresponding shared operator x. In the given example 300, MIB-1 301-1-c may point to SIB-1-1 302-1 associated with DU-1 326-1 of operator 1 and which is allocated in spectrum chunk 325-1, MIB-2 301-2 may point to SIB-1-2 302-2 associated with DU-2 326-2 of operator 2 and which is allocated in spectrum chunk 325-2, MIB-3 301-3 may point to SIB-1-3 302-3 associated with DU-3 326-3 of operator 3 and which is allocated in spectrum chunk 325-3, and MIB-4 301-4 may point to SIB-1-4 302-4 associated with DU-4 326-4 of operator 4 and which is allocated in spectrum chunk 325-4.

In an example, the shared RU 328 may receive the various information. The shared RU 328 may receive PSS 301-1-a, SSS 301-1-b, and MIB-1 301-1-c from DU-1 326-1. The shared RU 328 may further receive MIB-2 301-2 from DU-2 326-2, MIB-3 301-3 from DU-3 326-3, and MIB-4 301-4 from DU-4 326-4. The shared RU 328 may then generate the first SSB 301-1, the second SSB 301-2, the third SSB 301-3, and the fourth SSB 301-4, and transmit the SSBs in form of the modified SSB 301. Alternatively, the coordinating DU may receive the various information from the other DUs of the multiple DUs sharing the RU. The coordinating DU may then provide the modified SSB comprising the first SSB associated with the coordinating DU and the other SSBs associated with the other DUs to the shared RU. The shared RU may then transmit the modified SSB.

In an example, the DUs that are not identified as coordinating DUs refrain or are prevented from providing their own PSS and SSS for transmission. For the example 300 of FIG. 3, DU-2 326-2 associated with operator 2, DU-3 326-3 associated with operator 3, and DU-4 326-4 associated with operator 4 refrain or are prevented from providing their own PSS and SSS. Only, the coordinating DU-1 326-1 associated with operator 1 provides PSS 301-1-a and SSS 301-1-b for transmission. PSS 301-1-a and SSS 301-1-b provided by coordinating DU-1 326-1 associated with operator 1 are shared among all four DUs. These shared PSS 301-1-a and SSS 301-1-b are then used for facilitating synchronization at one or more receiving UEs. All DUs sharing the RU 328 may provide however their own MIB.

Sharing DU-1 326-1 may provide MIB-1 301-1-c for transmission by the shared RU 328, sharing DU-2 326-2 may provide MIB-2 301-2 for transmission by the shared RU 328, sharing DU-3 326-3 may provide MIB-3 301-3 for transmission by the shared RU 328, and sharing DU-4 326-4 may provide MIB-4 301-4 for transmission by the shared RU 328.

In other implementations, a higher or a lower number of DUs may share the shared RU 328, and any of the DUs may be identified as coordinating DU which may provide the synchronization information, which is in the given example PSS 301-1-a and SSS 301-1-b. This method allows sharing synchronization information in the form of a single PSS 301 and SSS 302 among multiple sharing DUs and avoids the transmission of multiple potentially identical synchronization information such as PSS and SSS. Thereby, the static energy consumption of the shared O-RAN architecture 100, 200 according to FIG. 1 and FIG. 2 can be reduced.

In an example, an SSB may comprise 821 symbols within a frame of, e.g., 20 ms duration. Each of PSS and SSS may be assigned 127 symbols. The MIB may therefore be assigned 567 symbols (821 symbols-2×127 symbols). From the 567 symbols assigned to the MIB, 246 symbols may be shared among a plurality of DUs, as they may be identical.

The remaining 321 symbols of the MIB may be unique for each DU and may hence not be shared among a plurality of DUs. For the above example with 4 DUs, assuming that each DU broadcasts via the shared RU its own SSB, then a total of 3.284 symbols may be transmitted. With the proposed method to share identical symbols among the 4 DUs, then only 2.522 symbols (2×127 symbols+4×567 symbols) may be transmitted. This leads to a reduction of the number of symbols to about 77%. This leads to an energy efficiency of about 23%.

As already indicated above, SSBs may be transmitted in an SSB burst. For example, in 5G, the transmission of SSB bursts may be used for beam sweeping. For beam sweeping, each SSB within an SSB burst may be identified by a unique SSB index. Each SSB may then be transmitted over a specific beam radiating in a certain direction. In this disclosure, in some aspects, additionally or alternatively of assigning different SSBs in an SSB burst to individual beams, different DUs in a shared RU scenario may also be assigned to different SSBs in the SSB burst.

FIG. 4 shows an example 400 of assigning SSBs in an SSB burst to different DUs sharing a shared RU 328 as shown in FIG. 3. The leftmost part of FIG. 4 shows an example of an SSB burst 400a comprising 4 SSBs 400a-x. These SSBs 440a-x may be transmitted by the shared RU 328 in a 5 ms window. Each SSB 400a-x in the SSB burst 400a may comprise PSS, SSS, and MIB. For beam sweeping in 5G, each SSB 400a-x in this burst may be assigned to one of four beams. In this disclosure, in one aspect, the SSBs 440a-x in the SSB burst 400a may be assigned to or associated with an individual DU of the multiple DUs. For the example of FIG. 4, there may be 4 DUs 326-1 to 326-4, and each DU may be associated with one of the SSBs in the SSB burst. As depicted in the central part of FIG. 4, the first SSB 400b-1 of the SSB burst 400b may be associated with DU-1 326-1, the second SSB 400b-2 of the SSB burst 400b may be associated with DU-2 326-2, the third SSB 400b-3 of the SSB burst 400b may be associated with DU-3 326-3, and the fourth SSB 400b-4 of the SSB burst 400b may be associated with DU-4 326-4.

In order to profit from static energy saving as discussed with respect to FIG. 3, the rightmost part of FIG. 4 shows the modified SSB transmitted as a modified SSB burst 400c for static energy saving. In this example, only the first SSB 400c-1 in the modified SSB burst 400c may comprise PSS, SSS, and MIB-1. For the remaining SSB-2 400c-2, SSB-3 400c-3, and SSB-4 400c-4, not the full SSBs may be transmitted. For these remaining SSBs (400c-2, 400c-3, 400c-4), the PSS and SSS can be omitted. Only the MIB-2, MIB-3, and MIB-4, respectively, may be transmitted, similarly as described with reference to FIG. 3. The first SSB 400c-1 of the modified SSB burst 400c may correspond to the first SSB 301-1, the second SSB 400c-2 of the modified SSB burst 400c may correspond to the second SSB 301-2, the third SSB 400c-3 of the modified SSB burst 400c may correspond to the third SSB 301-3, and the fourth SSB 400c-4 of the modified SSB burst 400c may correspond to the fourth SSB 301-4. Accordingly, instead of transmitting SSB-2 400b-2 in the burst, only MIB-2 may be transmitted, instead of transmitting SSB-3 400b-3 in the burst, only MIB-3 may be transmitted, and instead of transmitting SSB-4 400b-4 in the burst, only MIB-4 may be transmitted. In some implementations, such assignment of sharing DUs to SSBs in an SSB burst may be used in addition or alternatively to beam sweeping. The number of SSBs in an SSB burst may be adjustable and may cover as many sharing operators in the shared RU architecture and/or as many beams as necessary.

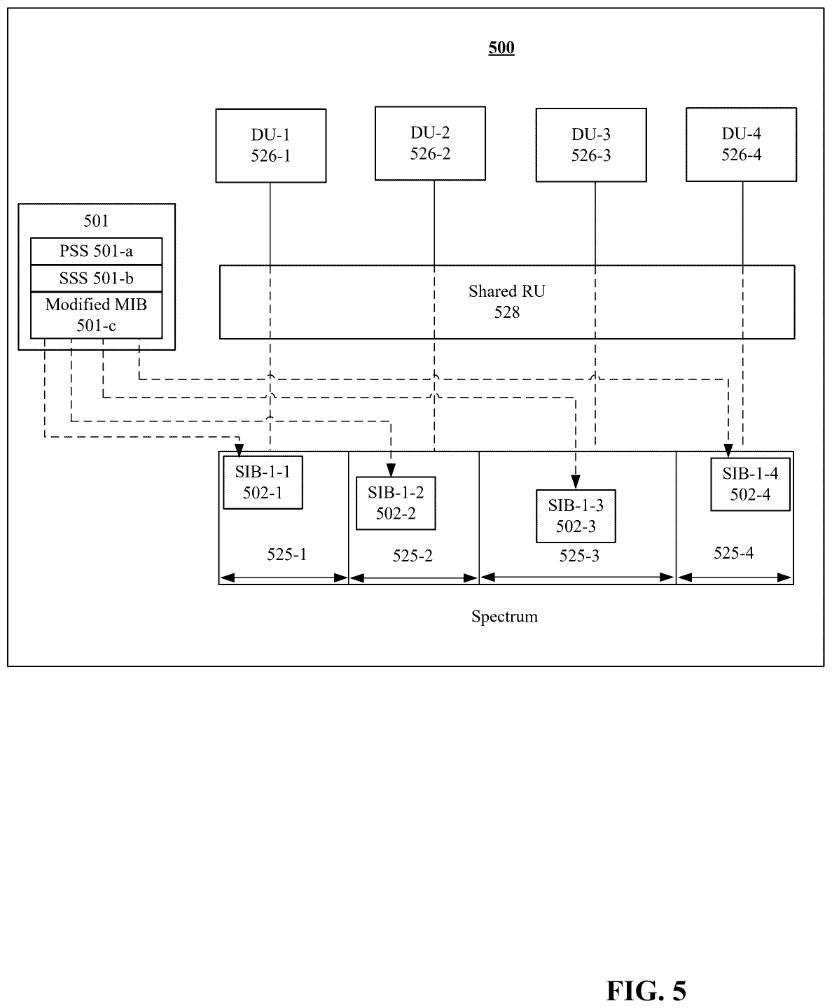

FIG. 5 shows a further example 500 on how to efficiently use SSBs among multiple sharing DUs in the shared RU architecture 200 according to FIG. 2. Again, for simplicity, the RICs RIC-x as well as the CUs CU-x are omitted in the example 500 of FIG. 5 similar to the example of FIG. 3. The example 500 is based on the example 300 of FIG. 3. Again, for this example 500, 4 sharing operators are illustrated, each having a DU-DU-x 526-x. Accordingly, operator 1 has DU-1 526-1, operator 2 has DU-2 526-2, operator 3 has DU-3 526-3, and operator 4 has DU-4 526-4. These four DUs 526-x share the shared RU 528, and the spectrum may be split up in non-overlapping chunks 525-1, 525-2, 525-3, and 525-4. Spectrum chunk 525-1 is associated with DU-1 526-1 of operator 1, spectrum chunk 525-2 is associated with DU-2 526-2 of operator 2, spectrum chunk 525-3 is associated with DU-3 526-3 of operator 3, and spectrum chunk 525-4 is associated with DU-4 526-4 of operator 4. In an example, one of the DUs may be a coordinating DU which may be configured to schedule or assign the spectrum chunks to the DUs. For example, the coordinating DU may transmit scheduling information to the other DUs. This scheduling information may be indicative of corresponding time and frequency at which the DUs can communicate with the RU. Similar to the example of FIG. 3, the information indicative of time and frequency allocations among the multiple DUs for sharing the RU may comprise information on the spectrum chunks 525-1 to 525-4 associated with the four DUs 526-1 to 526-4. In an example, the information on the spectrum chunks 525-1 to 525-4 may include a starting frequency, an end frequency, and/or a bandwidth of the spectrum chunks 525-1 to 525-4, and/or a duration during which a spectrum chunk may be used (e.g., 10 MHz from 7 am to 6 pm, and 5 MHz otherwise). In other implementations, other information that identify the spectrum chunks 525-1 to 525-4 may be used. In the given example, DU-1 526-1 may be identified as coordinating DU. In another example, the shared RU 528 may split up the spectrum.

The shared RU 528 may transmit the modified SSB 501. The modified SSB 501 in the given example also comprises the first SSB associated with the first DU-1 526-1, the second SSB associated with the second DU-2 526-2, the third SSB associated with the third DU-3 526-3, and the fourth SSB associated with the fourth DU-4 526-4. In contrast to the example 300 of FIG. 3 and the example 400 of FIG. 4, where the shared RU 328 may transmit the SSBs of the modified SSB individually, in this example, there may only be one transmission by the shared RU 528 of the modified SSB 501.

Additionally, the first SSB of the modified SSB 501 may comprise PSS 501-a and SSS 501-b. The first SSB may also comprise access information specific to the coordinating DU 526-1. In the given example, this access information is the MIB associated with DU-1 526-1. The further SSBs of the modified SSB 501 may comprise access information specific to a corresponding DU of the multiple DUs sharing the RU 528 similar as explained with regard to the example 300 of FIG. 3. In contrast to the example 300 of FIG. 3, in this example, a modified MIB 501-c is generated from the MIB information of all DUs sharing RU 528. In an example, the MIB information of the DUs 526-1 to 526-4 may be concatenated to generate the modified MIB 501-c. Again, each MIB in the modified MIB 501-c may point to a corresponding SIB-1 allocated somewhere in the spectrum chunk that is allocated to the corresponding DU. The modified MIB 501c may point to SIB-1-1 502-1 associated with DU-1 526-1 of operator 1 and which is allocated in spectrum chunk 525-1, to SIB-1-2 502-2 associated with DU-2 526-2 of operator 2 and which is allocated in spectrum chunk 525-2, to SIB-1-3 502-3 associated with DU-3 526-3 of operator 3 and which is allocated in spectrum chunk 525-3, and to SIB-1-4 502-4 associated with DU-4 526-4 of operator 4 and which is allocated in spectrum chunk 525-4.

In an example, the shared RU 528 may receive the various information. The shared RU 528 may receive PSS 501a, SSS 501-b, and MIB-1 from DU-1 526-1. The shared RU 528 may further receive MIB-2 from DU-2 526-2, MIB-3 from DU-3 526-3, and MIB-4 from DU-4 526-4. The shared RU 528 may then generate the modified SSB 501 and transmit the modified SSB 501. Alternatively, the coordinating DU (in the given example DU-1 526-1) may receive the various information from the other DUs of the multiple DUs sharing the RU 528. The coordinating DU may then generate and provide the modified SSB to the sharing RU 528. The sharing RU 528 may then transmit the modified SSB 501.

For the above example in which an SSB may comprise 821 symbols with each of PSS and SSS being assigned 127 symbols, and the MIB being assigned 567 symbols, and assuming that 246 symbols may be shared among a plurality of operators, and the remaining 321 symbols of the MIB may not be shared among a plurality of operators, the following energy efficiency may be obtained for example 500. For the example 500 with 4 operators, with the proposed method, only 1.784 symbols (2×127 symbols+246 symbols+4×321 symbols) may be transmitted. This leads to a reduction of the number of symbols to about 54%. This leads to an energy efficiency of about 46%.

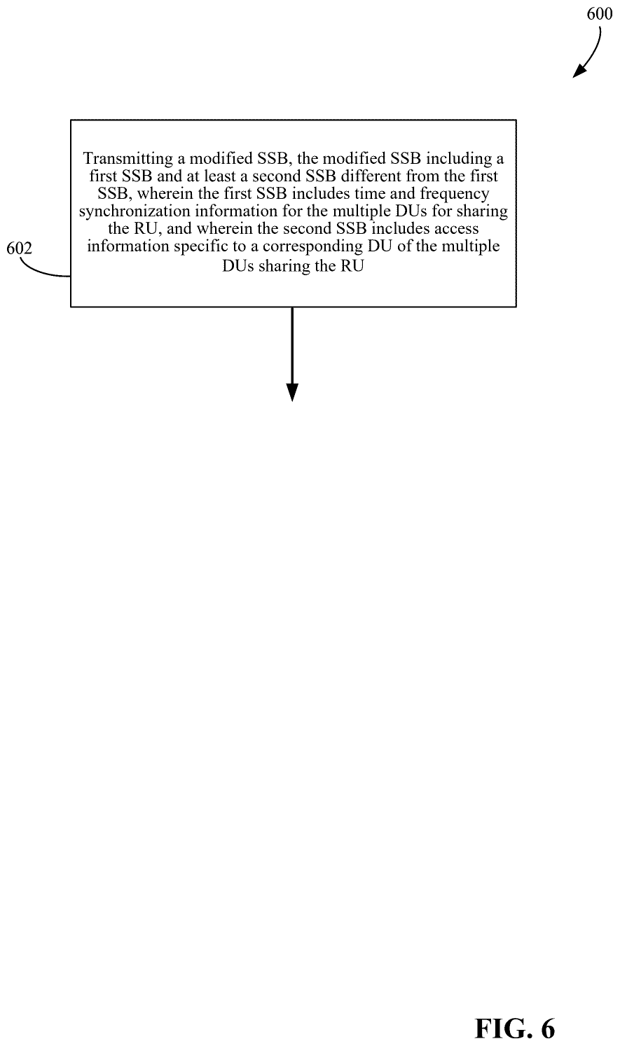

FIG. 6 is a flowchart of an example process 600 for reducing energy consumption. For convenience, the process 600 will be described as being performed by an apparatus comprising one or more computers, located in one or more locations, and programmed appropriately in accordance with this specification. The one or more computers may be configured to implement functionalities of an RU that is shared by multiple DUs of a RAN.

Operations of the process 600 include transmitting a modified SSB (602). The modified SSB includes a first SSB and at least a second SSB different from the first SSB. The first SSB includes time and frequency synchronization information for the multiple DUs for sharing the RU. The second SSB includes access information specific to a corresponding DU of the multiple DUs sharing the RU. For example, the modified SSB can correspond to modified SSB 301 of FIG. 3 or to modified SSB 501 of FIG. 5.

Optionally, operations of the process 600 can include one or more of the following. The first SSB of the modified SSB may include access information specific to a coordinating DU of the multiple DUs. The coordinating DU can be configured to share the time and frequency synchronization information among other DUs sharing the RU. For example, the coordinating DU can correspond to DU-1 326-1 of FIG. 3 or DU-1 526-1 of FIG. 5. The access information specific to the coordinating DU-1 326-1 of FIG. 3 may then correspond to MIB1 301-1-c.

Optionally, the first SSB of the modified SSB may comprise as time and frequency synchronization information a primary synchronization signal (PSS) and a secondary synchronization signal (SSS). In an example, the PSS and SSS may correspond to PSS 301-1-a and SSS 301-1-b of FIG. 3. In a further example, the PSS and SSS may correspond to PSS 501-a and SSS 501-b of FIG. 5.

Optionally, the access information in the second SSB comprises information indicative of a physical broadcast channel (PBCH) associated with the corresponding DU.

The PBCH may comprise a MIB associated with a corresponding DU. The MIB may further comprise information of a SIB associated with an operator of the corresponding DU. In an example, the MIB in the second SSB may correspond to MIB-1 301-2 associated with DU-2 326-2 of FIG. 3. Information in MIB-1 301-2 may point to SIB-1-2 302-2 associated with the operator of DU-2 326-2 of FIG. 3. Similar considerations apply to the example of FIG. 5. Optionally, the modified SSB comprises a third and a fourth SSB as exemplary shown in FIG. 3.

Optionally, the first SSB and the at least the second SSB of the modified SSB are transmitted in an information burst. The information burst includes multiple portions and each of the multiple portions of the information burst is associated with an individual DU of the multiple DUs. In an example, the information burst corresponds to the burst 400c of FIG. 4. The first portion of the burst corresponds to the first SSB 400c-1 comprising PSS and SSS as time and frequency synchronization information and MIB1 as access information, e.g., of DU-1 326-1 of FIG. 3. The second to fourth portions of the burst corresponds to the second to fourth SSB 400c-2 to 400c-4. Each of the second to fourth SSB comprises MIB2 to MIB4 as access information of, e.g., DU-2 326-2 to DU-4 326-4 of FIG. 3.

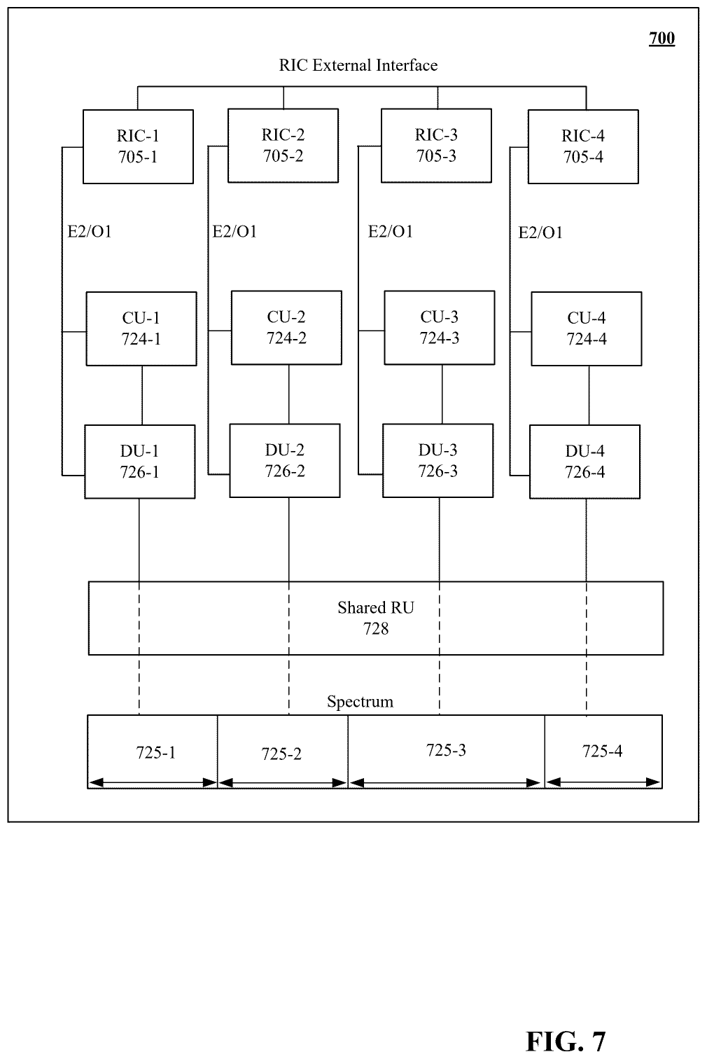

FIG. 7 shows an example of a shared RU architecture 700 enabling the described energy saving method of FIG. 6. The shared RU architecture 700 of FIG. 7 is similar to the shared RU architectures 200, 300, 500 of FIG. 2, FIG. 3 and FIG. 5. In the example shared RU architecture 700 of FIGS. 7, 4 operators run their individual components including RIC-x 705-x, CU-x 724-x, and DU-x 726-x. In particular, operator 1 runs RIC-1 705-1, CU-1 724-1, and DU-1 726-1, operator 2 runs RIC-2 705-2, CU-2 724-2, and DU-2 726-2, operator 3 runs RIC-3 705-3, CU-3 724-3, and DU-3 726-3, and operator 4 runs RIC-4 705-4, CU-4 724-4, and DU-4 726-4. All operators share shared RU 728. The available spectrum may be split in non-overlapping chunks 725-1, 725-2, 725-3, and 725-4. Spectrum chunk 725-1 is associated with DU-1 of operator 1, spectrum chunk 725-2 is associated with DU-2 of operator 2, spectrum chunk 725-3 is associated with DU-3 of operator 3, and spectrum chunk 725-4 is associated with DU-4 of operator 4.

For the energy saving methods described herein, in one aspect, one of the operators x may be designated as host operator. For ease of explanation, the host operator may be operator 1. The RIC run by the host operator may be denoted as coordinating RIC or host RIC. For the given example, the coordinating RIC may be RIC-1 705-1. In general, the host may be designated by agreement between the operators. In addition or alternatively, the operators may designate one of the RIC-x 705-x as coordinating RIC or host RIC. For purposes of simplicity, the coordinating RIC is RIC-1 705-1 associated with (host) operator 1. The coordinating RIC RIC-1 705-1 may communicate with the remaining RICs 705-2, 705-3, and 705-4 via the external interface.

The coordinating RIC 705-1 may be capable of controlling operations of multiple DUs 726-1, 726-2, 726-3, and 726-4 that share RU 728 of the RAN for implementing the energy saving methods described herein. In one example, the coordinating RIC 705-1 may transmit to the DUs 726-1, 726-2, 726-3, and 726-4 scheduling information indicative of corresponding time and frequency at which the DUs can communicate with the RU. The coordinating RIC 705-1 may transmit information on the spectrum chunks 725-1 to 725-4 associated with them to DUs 726-1 to 726-4. In an example, the information on the spectrum chunks 725-1 to 725-4 may include a starting frequency, an end frequency, and/or a bandwidth of the spectrum chunks 725-1 to 725-4, and/or a duration during which a spectrum chunk may be used (e.g., 10 MHz from 7 am to 6 pm, and 5 MHz otherwise). In other implementations, other information that identify the spectrum chunks 725-1 to 725-4 may be used. In an example, the coordinating RIC 705-1 may transmit the scheduling information to the individual DUs by communicating with RICs associated with each of the DUs such as those illustrated in FIG. 7. In other examples, the coordinating RIC may communicate directly with DUs 726-2 to 726-4.

The coordinating RIC 705-1 may further transmit to the DUs 726-2, 726-3, and 726-4 information configured to instruct the DUs 726-2, 726-3, and 726-4 to refrain from transmitting synchronization information. Similarly as above, the coordinating RIC 705-1 may transmit the information configured to instruct the DUs 726-2, 726-3, and 726-4 to refrain from transmitting synchronization information by communicating with RICs associated with each of the DUs such as those illustrated in FIG. 7. In other examples, the coordinating RIC may transmit this information directly to DUs 726-1 to 726-4. By preventing DUs 726-2, 726-3, and 726-4 from transmitting scheduling information, only the coordinating RIC 705-1 may provide the synchronization information. This scheduling information may then be shared among the multiple DUs 726-1, 726-2, 726-3, and 726-4, similarly as described above with regard to FIG. 3 to FIG. 6. The synchronization information may comprise a PSS and an SSS.

The coordinating RIC 705-1 may further transmit to the DUs 726-1, 726-2, 726-3, and 726-4 information configured to instruct the DUs 726-2, 726-3, and 726-4 to provide access information specific for each DU. Similarly as above, the coordinating RIC 705-1 may transmit the information configured to instruct the DUs 726-2, 726-3, and 726-4 to provide access information specific for each DU by communicating with RICs associated with each of the DUs such as those illustrated in FIG. 7. In other examples, the coordinating RIC may transmit this information directly to DUs 726-1 to 726-4. Thereby, each DU provides each own specific access information. Each specific access information may comprise information indicative of a physical broadcast channel (PBCH) associated with the corresponding DU. The PBCH may comprise a MIB associated with the corresponding DU. In an example, the remaining RICs 705-2, 705-3, and 705-4 or the DUs 726-2, 726-3, and 726-4 may provide the individual access information to the coordinating RIC 705-1. The coordinating RIC may then provide all access information to the shared RU 728. The shared RU 728 may then use the access information as discussed above with respect to FIG. 3 to FIG. 5. Alternatively, the DUs 726-1 to 726-4 may provide the individual access information to the shared RU 728 directly without transmitting the access information to the coordinating RIC 705-1.

In an example, the coordinating RIC 705-1 may communicate with the individual DUs instead of communicating with the individual RICs associated with the individual DUs to carry out the steps discussed above. In a further example, one of the DUs 726-1 to 726-4 may be identified as coordinating DU. This coordinating DU may perform all steps as discussed above with regard to the coordinating RIC. This reduces the requirements for the individual operators, as one or more RICs may not be needed.

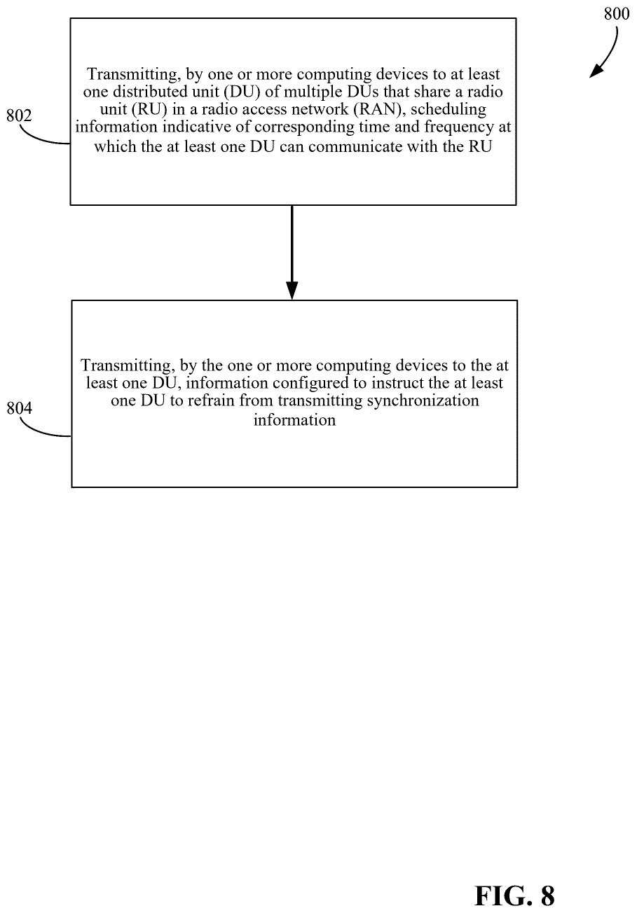

FIG. 8 is a flowchart of an example process 800 for controlling operations of multiple DUs that share an RU in a RAN such as to achieve a reduction of energy consumption as described herein. For convenience, the process 800 will be described as being performed by an apparatus comprising one or more computers, located in one or more locations, and programmed appropriately in accordance with this specification. The one or more computers may constitute a portion of a RIC.

Operations of the process 800 include transmitting to at least one DU of the multiple DUs scheduling information (802). The scheduling information is indicative of corresponding time and frequency at which the at least one DU can communicate with the RU. The scheduling information may be indicative of corresponding time and frequency at which the DUs can communicate with the RU. As described above with regard to FIG. 3, FIG. 5, and FIG. 7, the information indicative of time and frequency allocations among the multiple DUs for sharing the RU may comprise information on the spectrum chunks associated with each of the DUs. The information on the spectrum chunks may include in one example a starting frequency, an end frequency, and/or a bandwidth of the spectrum chunks. In other examples, other information that identify the spectrum chunks may be used. The transmission of the information indicative of time and frequency allocations may be as discussed above with respect to FIG. 7.

The process (800) also comprises the operation of transmitting to the at least one DU information configured to instruct the at least one DU to refrain from transmitting synchronization information. The transmission of the information to instruct the at least one DU to refrain from transmitting synchronization information may be as discussed above with respect to FIG. 7. This information can be in any form such that it is capable of informing a DU to refrain from transmitting synchronization information. Thereby, on one DU (e.g., a coordination DU) provides synchronization information which is then shared among the plurality of DUs that share the RU in a RAN. The synchronization information may comprise a PSS and an SSS.

Optionally, the process (800) may further comprise the operation of transmitting to the at least one DU information configured to instruct the at least one DU to provide access information specific to the at least one DU. The transmission of the information configured to instruct the at least one DU to provide access information specific to the at least one DU may be as discussed above with respect to FIG. 7. This information can be in any form such that it is capable of informing a DU to provide access information specific for this DU. The access information may comprise information indicative of a physical broadcast channel (PBCH) associated with the corresponding DU. The PBCH may comprise a MIB associated with the corresponding DU.

The example shared RU architectures shown in any of the above examples are only exemplary. The shared RU architectures may also follow the shared RU architecture of the O-RAN specification, e.g., the O-RAN Fronthaul specifications Version 10.00 which is incorporated herein by reference.

Embodiments of the subject matter and the actions and operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions, encoded on a computer program carrier, for execution by, or to control the operation of, data processing apparatus. The carrier may be a tangible non-transitory computer storage medium. Alternatively or in addition, the carrier may be an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program can be written in any form of programming language, including compiled or interpreted languages, or declarative or procedural languages; and it can be deployed on a system of one or more computers in any form, including as a stand-alone program, e.g., as an app, or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to, one or more mass storage devices, and be configured to receive data from or transfer data to the mass storage devices. The mass storage devices can be, for example, magnetic, magneto-optical, or optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on one or more computers having, or configured to communicate with, a display device, e.g., a LCD (liquid crystal display) or organic light-emitting diode (OLED) monitor, a virtual-reality (VR) or augmented-reality (AR) display, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback and responses provided to the user can be any form of sensory feedback, e.g., visual, auditory, speech or tactile; and input from the user can be received in any form, including acoustic, speech, or tactile input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions.

In addition to the embodiments of the attached claims and the embodiments described above, the following numbered embodiments are also innovative.

Embodiment 1 is a method of operating a radio unit (RU) shared by multiple distributed units (DUs) of a radio access network (RAN), the method comprising:
transmitting, by one or more computing devices, a modified synchronization signal block (SSB), wherein the modified SSB includes:
   a first SSB including time and frequency synchronization information for the multiple DUs for sharing the RU; and
   at least a second SSB different from the first SSB, wherein the second SSB includes access information specific to a corresponding DU of the multiple DUs sharing the RU.

Embodiment 2 is the method of embodiment 1, wherein the first SSB also includes access information specific to a coordinating DU of the multiple DUs, the coordinating DU configured to share the time and frequency synchronization information among other DUs of the multiple DUs.

Embodiment 3 is the method of any one of the embodiments 1 and 2, wherein functionalities of the shared RU are implemented using the one or more computing devices. Embodiment 4 is the method of any one of the embodiments 1 through 3, wherein transmitting the modified SSB comprises transmitting the first SSB and the at least the second SSB in an information burst, wherein the information burst includes multiple portions and each of the multiple portions of the information burst is associated with an individual DU of the multiple DUs.

Embodiment 5 is the method of any one of the embodiments 1 through 4, wherein the first SSB comprises a primary synchronization signal (PSS) and a secondary synchronization signal (SSS).

Embodiment 6 is the method of any one of the embodiments 1 through 5, wherein the access information in the second SSB comprises information indicative of a physical broadcast channel (PBCH) associated with the corresponding DU.

Embodiment 7 is the method of the embodiment 6, wherein the PBCH comprises a master information block (MIB) associated with the corresponding DU.

Embodiment 8 is the method of the embodiment 7, wherein the MIB comprises information of a system information block (SIB) associated with an operator of the corresponding DU.

Embodiment 9 is an apparatus for controlling operations of multiple distributed units (DUs) that share a radio unit (RU) in a radio access network (RAN), the apparatus comprising:

one or more computing devices, the one or more computing devices being configured to transmit a modified synchronization signal block (SSB), wherein the modified SSB includes a first SSB and a least a second SSB different from the first SSB, wherein the first SSB includes time and frequency synchronization information for the multiple DUs for sharing the RU, and wherein the second SSB includes access information specific to a corresponding DU of the multiple DUs sharing the RU.

Embodiment 10 is the apparatus of embodiment 9, wherein the first SSB also includes access information specific to a coordinating DU of the multiple DUs, the coordinating DU configured to share the time and frequency synchronization information among other DUs of the multiple DUs.

Embodiment 11 is the apparatus of any one of the embodiments 9 and 10, wherein the one or more computing devices are configured to implement functionalities of the shared RU. Embodiment 12 is the apparatus of any one of the embodiments 9 through 11, wherein transmitting the modified SSB comprises transmitting the first SSB and the at least the second SSB in an information burst, wherein the information burst includes multiple portions and each of the multiple portions of the information burst is associated with an individual DU of the multiple DUs.

Embodiment 13 is the apparatus of any one of the embodiments 9 through 12, wherein the first SSB comprises a primary synchronization signal (PSS) and a secondary synchronization signal (SSS).

Embodiment 14 is the apparatus of any one of the embodiments 9 through 13, wherein the access information in the second SSB comprises information indicative of a physical broadcast channel (PBCH) associated with the corresponding DU.

Embodiment 15 is the apparatus of embodiment 14, wherein the PBCH comprises a master information block (MIB) associated with the corresponding DU.

Embodiment 16 is the apparatus of embodiment 15, wherein the MIB comprises information of a system information block (SIB) associated with an operator of the corresponding DU.

Embodiment 17 is a non-transitory computer readable medium for operating a radio unit (RU) shared by multiple distributed units (DUs) of a radio access network (RAN), the non-transitory computer readable medium storing instructions that are executable by one or more computing devices, and upon such execution cause the one or more computing devices to perform operations comprising transmitting a modified synchronization signal block (SSB),
wherein the modified SSB includes a first SSB and at least a second SSB different from the first SSB,
wherein the first SSB includes time and frequency synchronization information for the multiple DUs for sharing the RU, and
wherein the second SSB includes access information specific to a corresponding DU of the multiple DUs sharing the RU.

Embodiment 18 is the non-transitory computer readable medium of embodiment 17, wherein the first SSB also includes access information specific to a coordinating DU of the multiple DUs, the coordinating DU configured to share the time and frequency synchronization information among other DUs of the multiple DUs.

Embodiment 19 is the non-transitory computer readable medium of any one of the embodiments 17 and 18, wherein functionalities of the shared RU are implemented using the one or more computing devices.

Embodiment 20 is the non-transitory computer readable medium of any one of the embodiments 17 through 19, wherein transmitting the modified SSB comprises transmitting the first SSB and the at least the second SSB in an information burst, wherein the information burst includes multiple portions and each of the multiple portions of the information burst is associated with an individual DU of the multiple DUs.

Embodiment 21 is the non-transitory computer readable medium of any one of the embodiments 17 through 20, wherein the first SSB comprises a primary synchronization signal (PSS) and a secondary synchronization signal (SSS).

Embodiment 22 is the non-transitory computer readable medium of any one of the embodiments 17 through 21, wherein the access information in the second SSB comprises information indicative of a physical broadcast channel (PBCH) associated with the corresponding DU.

Embodiment 23 is the non-transitory computer readable medium of the embodiment 22, wherein the PBCH comprises a master information block (MIB) associated with the corresponding DU.

Embodiment 24 is the non-transitory computer readable medium of the embodiment 23, wherein the MIB comprises information of a system information block (SIB) associated with an operator of the corresponding DU.

Embodiment 25 is a computer program comprising instructions, which, when executed by one or more computing devices, cause the one or more computing devices to carry out the method of any one of the embodiments 1 through 8.

Embodiment 26 is a method for controlling operations of multiple distributed units (DUs) that share a radio unit (RU) in a radio access network (RAN), the method comprising:
transmitting, by one or more computing devices to at least one DU of the multiple DUs, scheduling information indicative of corresponding time and frequency at which the at least one DU can communicate with the RU; and
transmitting, by the one or more computing devices to the at least one DU, information configured to instruct the at least one DU to refrain from transmitting synchronization information.

Embodiment 27 is the method of embodiment 26, wherein the one or more computing devices constitute a portion of a RAN Intelligent controller (RIC).

Embodiment 28 is the method of any one of the embodiments 26 and 27, further comprising:
transmitting, by the one or more computing devices to the at least one DU, information configured to instruct the at least one DU to provide access information specific to the at least one DU.

Embodiment 29 is the method of any one of the embodiments 26 through 28, wherein the synchronization information comprises a primary synchronization signal (PSS) and a secondary synchronization signal (SSS).

Embodiment 30 is the method of any one of the embodiments 28 and 29, wherein the access information specific to the at least one DU comprises information indicative of a physical broadcast channel (PBCH) associated with the at least one DU.

Embodiment 31 is the method of the embodiment 30, wherein the PBCH comprises a master information block (MIB) associated with the at least one DU.

Embodiment 32 is an apparatus for controlling operations of multiple distributed units (DUs) that share a radio unit (RU) in a radio access network (RAN), the apparatus comprising:
one or more computing devices configured to carry out operations comprising:
   transmitting to at least one DU of the multiple DUs scheduling information, wherein the scheduling information is indicative of corresponding time and frequency at which the at least one DU can communicate with the RU; and
   transmitting to the at least one DU information configured to instruct the at least one DU to refrain from transmitting synchronization information.

Embodiment 33 is the apparatus of embodiment 32, wherein the one or more computing devices are configured to constitute a portion of a RAN Intelligent controller (RIC).

Embodiment 34 is the apparatus of any one of the embodiments 32 and 33, wherein the one or more computing devices are further configured to transmit to the at least one DU information configured to instruct the at least one DU to provide access information specific to the at least one DU.

Embodiment 35 is the apparatus of any one of the embodiments 32 through 34,wherein the synchronization information comprises a primary synchronization signal (PSS) and a secondary synchronization signal (SSS).

Embodiment 36 is the apparatus of any one of the embodiments 34 and 35, wherein the access information specific to the at least one DU comprises information indicative of a physical broadcast channel (PBCH) associated with the at least one DU.

Embodiment 37 is the apparatus of the embodiment 36, wherein the PBCH comprises a master information block (MIB) associated with the at least one DU.

Embodiment 38 is a non-transitory computer readable medium for controlling operations of multiple distributed units (DUs) that share a radio unit (RU) in a radio access network (RAN), the non-transitory computer readable medium storing instructions that are executable by one or more computing devices, and upon such execution cause the one or more computing devices to perform operations comprising:
transmitting to at least one DU of the multiple DUs scheduling information, wherein the scheduling information is indicative of corresponding time and frequency at which the at least one DU can communicate with the RU; and
transmitting to the at least one DU information configured to instruct the at least one DU to refrain from transmitting synchronization information.

Embodiment 39 is the non-transitory computer readable medium of embodiment 38, wherein the one or more computing devices constitute a portion of a RAN Intelligent controller (RIC).

Embodiment 40 is the non-transitory computer readable medium of any one of the embodiments 38 and 39, further comprising:
transmitting, by the one or more computing devices to the at least one DU, information configured to instruct the at least one DU to provide access information specific to the at least one DU.

Embodiment 41 is the non-transitory computer readable medium of any one of the embodiments 38 through 40, wherein the synchronization information comprises a primary synchronization signal (PSS) and a secondary synchronization signal (SSS).

Embodiment 42 is the non-transitory computer readable medium of any one of the embodiments 40 and 41, wherein the access information specific to the at least one DU comprises information indicative of a physical broadcast channel (PBCH) associated with the at least one DU.

Embodiment 43 is the non-transitory computer readable medium of the embodiment 42, wherein the PBCH comprises a master information block (MIB) associated with the at least one DU.

Embodiment 44 is a computer program comprising instructions, which, when executed by one or more computing devices, cause the one or more computing devices to carry out the method of any one of the embodiments 26 through 31.

While this specification contains many specific implementation details, these should not be construed as limitations on the scope of what is being claimed, which is defined by the claims themselves, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method for controlling operations of multiple distributed units (DUs) that share a radio unit (RU) in a radio access network (RAN), the method comprising:
transmitting, by one or more computing devices to at least one DU of the multiple DUs, scheduling information indicative of corresponding time and frequency at which the at least one DU can communicate with the RU; and
transmitting, by the one or more computing devices to the at least one DU, information configured to instruct the at least one DU to refrain from transmitting synchronization information.

2. The method of claim 1, wherein the one or more computing devices constitute a portion of a RAN Intelligent controller (RIC).

3. The method of claim 1, further comprising:
transmitting, by the one or more computing devices to the at least one DU, information configured to instruct the at least one DU to provide access information specific to the at least one DU.

4. The method of claim 1, wherein the synchronization information comprises a primary synchronization signal (PSS) and a secondary synchronization signal (SSS).

5. The method of claim 3, wherein the access information specific to the at least one DU comprises information indicative of a physical broadcast channel (PBCH) associated with the at least one DU.

6. The method of claim 5, wherein the PBCH comprises a master information block (MIB) associated with the at least one DU.

7. An apparatus for controlling operations of multiple distributed units (DUs) that share a radio unit (RU) in a radio access network (RAN), the apparatus comprising:
one or more computing devices, the one or more computing devices being configured to
transmit to at least one DU of the multiple DUs scheduling information indicative of corresponding time and frequency at which the at least one DU can communicate with the RU; and
transmit to the at least one DU information configured to instruct the at least one DU to refrain from transmitting synchronization information.

8. The apparatus of claim 7, wherein the one or more computing devices constitute a portion of a RAN Intelligent controller (RIC).

9. The apparatus of claim 7, wherein the one or more computing devices are further configured to transmit to the at least one DU information configured to instruct the at least one DU to provide access information specific to the at least one DU.

10. The apparatus of claim 7, wherein the synchronization information comprises a primary synchronization signal (PSS) and a secondary synchronization signal (SSS).

11. The apparatus of claim 9, wherein the access information specific to the at least one DU comprises information indicative of a physical broadcast channel (PBCH) associated with the at least one DU.

12. The apparatus of claim 11, wherein the PBCH comprises a master information block (MIB) associated with the at least one DU.

13. A non-transitory computer readable medium controlling operations of multiple distributed units (DUs) that share a radio unit (RU) in a radio access network (RAN), the non-transitory computer readable medium storing instructions that are executable by one or more computing devices, and upon such execution cause the one or more computing devices to perform operations comprising:
transmitting to at least one DU of the multiple DUs scheduling information indicative of corresponding time and frequency at which the at least one DU can communicate with the RU; and
transmitting to the at least one DU information configured to instruct the at least one DU to refrain from transmitting synchronization information.

14. The non-transitory computer readable medium of claim 13, wherein the one or more computing devices constitute a portion of a RAN Intelligent controller (RIC).

15. The non-transitory computer readable medium of claim 13, wherein the non-transitory computer readable medium further stores instructions that are executable by one or more computing devices, and upon such execution cause the one or more computing devices to perform operations comprising:
transmitting to the at least one DU information configured to instruct the at least one DU to provide access information specific to the at least one DU.

16. The non-transitory computer readable medium of claim 13, wherein the synchronization information comprises a primary synchronization signal (PSS) and a secondary synchronization signal (SSS).

17. The non-transitory computer readable medium of claim 15, wherein the access information specific to the at least one DU comprises information indicative of a physical broadcast channel (PBCH) associated with the at least one DU.

18. The non-transitory computer readable medium of claim 17, wherein the PBCH comprises a master information block (MIB) associated with the at least one DU.

19-35. (canceled)
